(19) United States
(12) Patent Application Publication
(10) Pub. No.: US 2023/0138835 A1
(43) Pub. Date: May 4, 2023

(54) KITCHEN GADGET SET

(71) Applicant: Yingying Xiao, Yichun City (CN)

(72) Inventor: Yingying Xiao, Yichun City (CN)

(21) Appl. No.: 17/824,315

(22) Filed: May 25, 2022

(30) Foreign Application Priority Data
Oct. 30, 2021 (CN) 202122631303.1

(51) Int. Cl. A47J 17/02; B26B 25/00; B67B 7/16

(52) U.S. Cl. CPC A47J 17/02; B26B 25/005; B67B 7/16

(57) ABSTRACT

A kitchen gadget set includes a pizza cutter and a second housing formed by butting a first half housing and a second half housing together, where the pizza cutter includes a first housing with a first insertion slot; the first housing is provided therein with a circular blade; the circular blade is provided with a central portion hinged to the first housing through a hinge shaft and a side located outside the first insertion slot; the first half housing is provided with a vegetable and fruit shredding plate, and a side of the second half housing is provided with a grating region for grating garlic and ginger, etc.; and the second housing is further provided therein with a peeler and a bottle opener.

### CROSS REFERENCE TO RELATED APPLICATION

This application claims priority benefit of Chinese design Application No. 202122631303.1, filed on Oct. 30, 2021, and the entire contents of which are incorporated herein by reference.

### FIELD OF THE INVENTION

The present disclosure relates to kitchenwares, and in particular to A kitchen gadget set.

### BACKGROUND OF THE INVENTION

Cooking in the kitchen is inseparable from various gadgets, such as a peeler for paring vegetables and fruits, a shredder for making fine shreds of cucumbers, potatoes, ginger, etc., and a grater for making fine powders such as garlic and ginger. At present, various kitchen gadgets are designed and sold separately, and customers can only buy single-function tools, which is much inconvenient. In addition, during cooking, the various gadgets scattering on the countertop often makes the kitchen messy.

### SUMMARY OF THE INVENTION

The present disclosure provides A kitchen gadget set for solving the problem that various kitchen gadgets in the prior art are inconvenient to use and make the kitchen messy.

In order to solve the above problem, the present disclosure adopts the following solution:

A kitchen gadget set includes:

a pizza cutter, where the pizza cutter includes a first housing with a first insertion slot; the first housing is provided therein with a circular blade; and the circular blade is provided with a central portion hinged to the first housing through a hinge shaft and a side located outside the first insertion slot; and

a first half housing and a second half housing, where the first half housing is provided with a shredding plate, and a side of the second half housing is provided with a grating region, which is provided with multiple grating protrusions; and

a second housing is formed by butting the first half housing and the second half housing together through a detachable structure; and an end of each of the first half housing and the second half housing is provided with an insertion portion, through which the second housing is connected to the first insertion slot.

Preferably, the detachable structure includes a protrusion provided on a side of the second half housing and a slot provided on a side of the first half housing.

Preferably, the detachable structure includes a first magnetic piece provided on a side of the first half housing and a second magnetic piece provided on a side of the second half housing.

Preferably, the kitchen gadget set further includes a bottle opener which is provided in the second housing.

Preferably, the bottle opener includes a flat plate with two circular ends, one of which is provided therein with a metal pinch plate; and the pinch plate includes a central bottle opening hole and a bottle opening protrusion located on a lower side of the bottle opening hole.

Preferably, the kitchen gadget set further includes a peeler which is provided in the second housing.

Preferably, the peeler includes a knife handle and a knife head; the knife handle is a flat shell with an insertion opening at a front end; the knife head includes a blade and an insertion portion provided at a rear end of the blade; and front and rear ends of the insertion portion is respectively provided with a first insertion piece and a second insertion piece that is corresponding to the insertion opening.

Preferably, the first housing and the second housing is butted together to form a flat housing with two circular ends.

Compared with the prior art, the present disclosure has the following beneficial effects. The kitchen gadget set includes a pizza cutter and a second housing formed by butting a first half housing and a second half housing together. The first half housing is provided with a vegetable and fruit shredding plate, and a side of the second half housing is provided with a grating region for grating garlic and ginger, etc. The second housing is further provided therein with a peeler and a bottle opener. The kitchen gadget set has various uses, and the first housing of the pizza cutter and the second housing can be butted together to form an integral housing, so as to assemble the kitchen gadget set in a small volume, making it convenient to store.

### BRIEF DESCRIPTION OF THE DRAWINGS

The drawings are provided for further understanding of the invention and constitute a part of the specification. The drawings, together with the embodiments of the invention, are intended to explain the invention, rather than to limit the invention. Drawings:

FIG. 1 is a three-dimensional view of A kitchen gadget set according to an embodiment of the present disclosure;

FIG. 2 is an exploded view of the kitchen gadget set according to an embodiment of the present disclosure;

FIG. 3 is a three-dimensional view of a first half housing of the kitchen gadget set according to an embodiment of the present disclosure;

FIG. 4 is an exploded view of a peeler of the kitchen gadget set according to an embodiment of the present disclosure; and

FIG. 5 is an exploded view of a first housing of a pizza cutter of the kitchen gadget set according to an embodiment of the present disclosure.

Reference Numerals: 1. pizza cutter; 11. first housing; 111. first insertion slot; 112. upper half housing; 113. lower half housing; 114. third magnetic piece; 115. recess; 12. circular blade; 121. hinge shaft; 2. second housing; 21. first half housing; 211. shredding plate; 212. insertion portion; 213. slot; 214. first magnetic piece; 22. second half housing; 221. grating protrusion; 222. protrusion; 223. second magnetic piece; 3. peeler; 31. knife head; 311. blade; 312. insertion portion; 3121. first insertion piece; 3122. second insertion piece; 32. knife handle; 321. insertion opening; 4. bottle opener; 41. flat plate; 42. pinch plate; 421. bottle opening hole; and 422. bottle opening protrusion.

### DETAILED DESCRIPTION OF THE EMBODIMENTS

The solutions in the embodiments of the invention are described clearly and completely below with reference to the drawings in the embodiments of the invention. Apparently, the described embodiments are merely a part, rather than all of the embodiments of the invention. All other embodiments obtained by those of ordinary skill in the art based on the embodiments in the invention without creative efforts should fall within the protection scope of the invention.

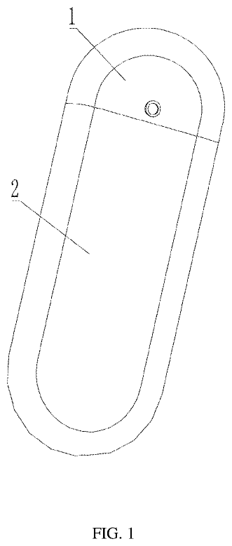

The present disclosure provides A kitchen gadget set, as shown in FIGS. 1 to 5.

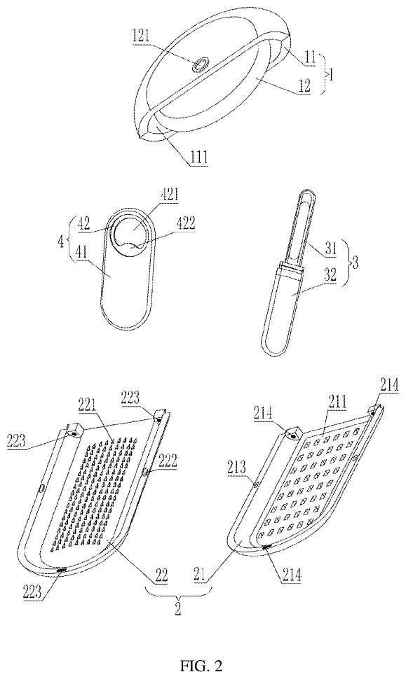

As shown in FIG. 1, the kitchen gadget set includes a pizza cutter 1. As shown in FIG. 2, the pizza cutter 1 includes a first housing 11 with a first insertion slot 111. The first housing 11 is provided therein with a circular blade 12, and the circular blade 12 is made of metal. An outer periphery of the circular blade 12 is provided with a cutting edge. A central portion of the circular blade 12 is hinged to the first housing 11 through a hinge shaft 121, and a side of the circular blade 12 is located outside the first insertion slot 111. The first housing 11 is held to cut a pizza by the circular blade 12.

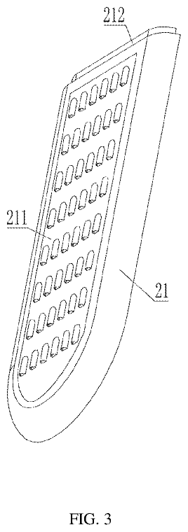

As shown in FIG. 1, the kitchen gadget set further includes a second housing 2. The first housing 11 and the second housing 2 are butted together to form a flat housing with two circular ends. As shown in FIGS. 2 and 3, the second housing 2 is formed by butting a first half housing 21 and a second half housing 22 together through a detachable structure. The first half housing 21 is provided with a shredding plate 211. As shown in FIG. 3, a rear side of the shredding plate 211 is provided with multiple arc-shaped shredding blades that protrude rearward. The shredding plate 211 is configured to shred a cucumber, ginger, etc. A side of the second half housing 22 is provided with a grating region. The grating region is provided with multiple grating protrusions 221. The grating protrusions 221 in the grating region are triangular, and are configured to grate garlic, ginger, etc.

As shown in FIG. 3, an end of the first half housing 21 is provided with an insertion portion 212 matched with the first insertion slot 111. Similarly, an end of the second half housing 22 is also provided with an insertion portion, such that the second housing 2 is connected to the first insertion slot 111 through the insertion portion.

Further, as shown in FIG. 2, the detachable structure includes a protrusion 222 provided on a side of the second half housing 22 and a slot 213 provided on a side of the first half housing 21. In addition, the detachable structure further includes a first magnetic piece 214 provided on a side of the first half housing 21 and a second magnetic piece 223 provided on a side of the second half housing 22. These magnetic pieces make the first half housing 21 and the second half housing 22 attracted and butted together.

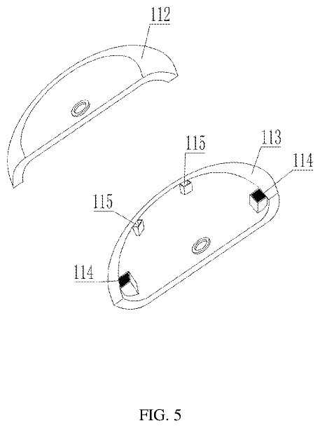

Further, as shown in FIG. 5, the first housing 11 is formed by butting an upper half housing 112 and a lower half housing 113. Outer sides of the upper half housing 112 and the lower half housing 113 are respectively provided with third magnetic pieces 114. A recess 115 is provided on a side of the lower half housing 113, and an insertion rod is correspondingly provided on a side of a bottom surface of the upper half housing 112. The upper half housing 112 and the lower half housing 113 are butted together through the insertion rod and the recess 115, and are attracted together by the third magnetic pieces 114. In addition, when the second housing 2 is inserted into the first housing 11, the first magnetic piece 214 at a front end of the first half housing 21 and the second magnetic piece 223 at a front end of the second half housing 22 are attracted, and the third magnetic pieces 114 in the first housing 11 are attracted.

Further, as shown in FIG. 2, the kitchen gadget set includes a peeler 3 and a bottle opener 4 which are provided in the second housing 2. The bottle opener 4 includes a flat plate 41, and the flat plate 41 is provided with two circular ends. A pinch plate 42 is embedded in one end of the flat plate 41. The flat plate 41 is made of an engineering plastic, and the pinch plate 42 is made of a metal. A bottle opening hole 421 is provided in a central portion of the pinch plate 42. The pinch plate 42 includes a bottle opening protrusion 422 located on a lower side of the bottle opening hole 421. To open a bottle cap, a side of the bottle cap is placed into the bottle opening hole 421, and the bottle cap is pried off through the bottle opening protrusion 422.

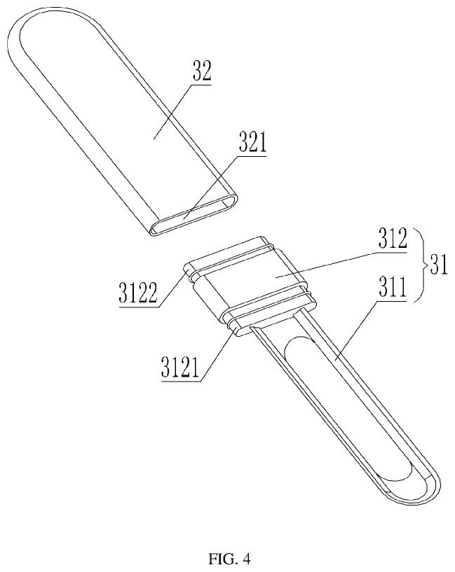

As shown in FIG. 2, the peeler 3 includes a knife handle 32 and a knife head 31. As shown in FIG. 4, the knife handle 32 is a flat shell, and the knife handle 32 is provided with a front end with an insertion opening 321. The knife head 31 includes a blade 311 and an insertion portion 312 provided at a rear end of the blade 311. Front and rear ends of the insertion portion 312 are respectively provided with a first insertion piece 3121 and a second insertion piece 3122 that are corresponding to the insertion opening 321. The blade 311 is configured to peel the skin of a fruit or vegetable off. A central portion of the blade is provided with an elongated hole, and a cutting edge is provided at a side of the elongated hole. To put the peeler 3 into the second housing 2, the blade 311 of the knife head 31 is put into the knife handle 32, and the first insertion piece 3121 is inserted into the insertion opening 321, such that the peeler 3 is in a hidden state. To use the peeler 3, the second insertion piece 3122 is inserted into the insertion opening 321, such that the peeler 3 is in an unfolded state.

With the ingenious design, the kitchen gadget set can be assembled in a small volume as shown in FIG. 1, and can be disassembled as shown in FIG. 2, making the kitchen gadget set easy to use and store.

It should be noted that relational terms herein such as first and second are merely used to distinguish one entity or operation from another entity or operation without necessarily requiring or implying any actual such relationship or order between such entities or operations. In addition, terms “include”, “comprise”, or any other variations thereof are intended to cover a non-exclusive inclusion, so that a process, a method, an article, or a device including a series of elements not only includes those elements, but also includes other elements that are not explicitly listed, or also includes inherent elements of the process, the method, the article, or the device.

Although the embodiments of the invention are described, it should be understood that those of ordinary skill in the art may make various changes, modifications, replacements, and variations to the above embodiments without departing from the principle and spirit of the invention, and the scope of the invention is subjected to the appended claims and legal equivalents thereof.

What is claimed is:

1. A kitchen gadget set, comprising:
a pizza cutter, wherein the pizza cutter comprises a first housing with a first insertion slot; the first housing is provided therein with a circular blade; and the circular blade is provided with a central portion hinged to the first housing through a hinge shaft and a side located outside the first insertion slot; and
a first half housing and a second half housing, wherein the first half housing is provided with a shredding plate, and a side of the second half housing is provided with a grating region, which is provided with multiple grating protrusions;
wherein a second housing is formed by butting the first half housing and the second half housing together through a detachable structure; and an end of each of the first half housing and the second half housing is provided with an insertion portion, through which the second housing is connected to the first insertion slot.

2. The kitchen gadget set according to claim 1, wherein the detachable structure comprises a protrusion provided on a side of the second half housing and a slot provided on a side of the first half housing.

3. The kitchen gadget set according to claim 1, wherein the detachable structure comprises a first magnetic piece provided on a side of the first half housing and a second magnetic piece provided on a side of the second half housing.

4. The kitchen gadget set according to claim 1, wherein the kitchen gadget set further comprises a bottle opener which is provided in the second housing.

5. The kitchen gadget set according to claim 4, wherein the bottle opener comprises a flat plate with two circular ends, one of which is provided therein with a metal pinch plate; and the pinch plate comprises a central bottle opening hole and a bottle opening protrusion located on a lower side of the bottle opening hole.

6. The kitchen gadget set according to claim 1, wherein the kitchen gadget set further comprises a peeler which is provided in the second housing.

7. The kitchen gadget set according to claim 6, wherein the peeler comprises a knife handle and a knife head; the knife handle is a flat shell with an insertion opening at a front end; the knife head comprises a blade and an insertion portion provided at a rear end of the blade; and front and rear ends of the insertion portion are respectively provided with a first insertion piece and a second insertion piece that are corresponding to the insertion opening.

8. The kitchen gadget set according to claim 1, wherein the first housing and the second housing are butted together to form a flat housing with two circular ends.
